(19) United States
(12) Patent Application Publication
(10) Pub. No.: US 2007/0002779 A1
(43) Pub. Date: Jan. 4, 2007

(54) Method and system for providing PTT to conference

(75) Inventors: Eun-Kyoung Lee, Suwon-si (KR); Young-Ki Jeon, Hwanseong-gun (KR); Ju-Young Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/452,210

(22) Filed: Jun. 14, 2006

(30) Foreign Application Priority Data
Jun. 15, 2005 (KR) 2005-51504
Jun. 15, 2005 (KR) 2005-51507
Oct. 31, 2005 (KR) 2005-103234

(51) Int. Cl. H04L 12/16

(52) U.S. Cl. 370/260; 455/90.2

(57) ABSTRACT

A method for providing push-to-talk (PTT) so as to conference between a plurality of user equipments (UEs) serving as clients in a mobile communication network including a PTT over cellular (PoC) server, a conference server, and a mixer for mixing for the conference. The method comprises performing a request procedure for switching over to the conference during a PoC session between the UEs; performing a conference client invitation or participation procedure for opening a conference session through the conference server; and performing a procedure for releasing the conference session between the PoC server and the UEs. The method can switch over to a conference service during a PTT service without newly initializing the conference service after completing an old PoC session, and can also switch over to bidirectional communication between all or some of the participants during a PoC session which is using unidirectional communications.

### CROSS-REFERENCE TO RELATED APPLICATIONS

This application claims the benefit under 35 U.S.C. §119(a) of Korean Patent Application No. 2005-51504, filed Jun. 15, 2005, in the Korean Intellectual Property Office, Korean Patent Application No. 2005-51507, filed Jun. 15, 2005, in the Korean Intellectual Property Office, and Korean Patent Application No. 2005-103234, filed Oct. 31, 2005, in the Korean Intellectual Property Office, the entire disclosures of which are hereby incorporated by reference.

### BACKGROUND OF THE INVENTION

1. Field of the Invention

The present invention relates to a method and system for providing a Push to talk over Cellular (PoC) service in a cellular network. More particularly, the present invention relates to a method and system for providing a Push-To-Talk (PTT) to conference service.

2. Description of the Related Art

A PTT service is an instant messaging service that is a type of the walkie-talkie service. The PTT service is advantageous in that it enables a user to instantly communicate for a short period of time by pressing a switch. The PTT service operates without unnecessary processes such as dialing and ringing. Thereby, terminals are more rapidly connected and have a shorter wait time, when compared to a conventional communications service. Further, the PTT service can increase convenience to a user because it instantly displays on the terminal screen information indicating whether another party is in a ready-to-receive state.

The PTT service having the above advantages has the major service functions of providing unidirectional voice broadcasting, transmitting packetized voice through a wireless data network, supporting personal and group messaging, supporting an instant access, and providing a simple user interface.

PTT over Cellular (PoC) incorporates the above PTT service functions in an existing cellular or PCS terminal. Currently, standardization of the PTT service is in progress and is centering around the Open Mobile Alliance (OMA). Further, research on the IP Multimedia Subsystem (IMS)-based PTT service is also being conducted in the 3rd Generation Partnership Project (3GPP).

FIG. 1 is a conceptual diagram of a PTT service network for a conventional PTT service.

Referring to FIG. 1, there is shown a scenario where a calling party 100, which is a member in a calling party group, performs a PTT conversation with one or more of the called parties 101, 103, 105 and 107 that make up a called party group. The PTT conversation occurs through a wireless network 109. If the calling party 100 initiates a conversation by pressing a switch, the called party group, including at least one called party, receives voice information of the calling party 100. In this conventional PTT service, the calling party 100 previously designates at least one called party group and has a conversation, which is like a walkie-talkie conversation, with only one called party in the designated called party group.

FIG. 2 is a diagram illustrating a configuration of an OMA-based PTT service network.

Referring to FIG. 2, the OMA-based PTT service network includes a User Equipment (UE) 200, an XML Document Management Server (XDMS) 212, a presence server 208, a Session Initiation Protocol (SIP) proxy 206, and a PoC server 201 with a packet processor 202.

The UE 200 is a terminal device capable of supporting the PTT service, and the XDMS 212 is a server for managing XML documents. The presence server 208 and the SIP proxy 206 are entities for relaying the PTT service by performing functions defined in the SIP standard, and the PoC server 201 is a server for enabling the PTT service in the cellular network. The entire SIP standard is hereby incorporated by reference.

Interfaces of the entities constituting the OMA-based PTT service network have the following functions. A UE-XDMS interface 210 is an interface for inquiring/receiving a group list and policy information via an access network 211. An XDMS-PoC server interface 213 is an interface for inquiring/receiving a group list and policy information for the PoC service. An XDMS-presence server interface 209 is an interface for inquiring/receiving policy information for the presence service.

In addition, an SIP proxy-presence server interface 207 is used for registering/storing/deleting/inquiring participation information of a user based on SIP as an access standard between the SIP proxy 206 and the presence server 208. A UE-SIP proxy interface 204, which is an interface for transmitting signaling for a PoC session between a PoC client and a PoC server via the access network 211, supports the SIP, provides PoC client registration, and performs authentication/authority on a PoC USER. A UE-PoC server interface 203 is used for media transmission and talk burst control, and thus a Real-time Transport Protocol/RTP Control Protocol (RTP/RTCP) is used. The SIP proxy-PoC server interface 205, which is an interface for transmitting signaling for a PoC session between the PoC client and the PoC server, supports the SIP and is used for billing.

FIG. 3 is a diagram illustrating a call setup process for an IMS-based PTT service.

Referring to FIG. 3, the OMA-based PTT service can be classified as a call flow between a PoC Client A Home & Controlling Network 320 and a PoC Client B Home Network 330. The PoC Client A Home & Controlling Network 320 includes a PoC client A 321, an SIP/IP core A 322, and a PoC server (A)-participating & controlling 323. The PoC Client B Home Network 330 includes a PoC server (B)-participating 331, an SIP/IP core B 332, and a PoC client B 333.

In step 301, the PoC client A 321 sends an Invite message to the SIP/IP core A 322 to initialize an ad-hoc PoC group session or a 1-1 PoC session. In-step 302, the SIP/IP core A 322 routes the Invite message to the PoC server (A)-participating & controlling 323 based on an Inviting PoC Address of a PoC user in PoC client and PoC service indication.

In step 303, the PoC server (A)-participating & controlling 323 sends an Invite message to the SIP/IP core A 322. In step 304, the SIP/IP core A 322 routes the Invite message to the SIP/IP core B 332. In step 305, the SIP/IP core B 332 routes the Invite message to the PoC server (B)-participating 331 based on a PoC address of Invited PoC Client and PoC service indication.

In step 306, if the PoC client B 333 automatically accepts the session, the PoC server (B)-participating 331 sends an Auto-Answer message to the SIP/EP core B 332. In step 307, the SIP/IP core B 332 forwards the Auto-Answer message to the SIP/IP core A 322.

In step 308a, the SIP/IP core A 322 forwards the Auto-Answer message to the PoC server (A)-participating & controlling 323. In step 308b, the PoC server (B)-participating 331 sends an Invite message for requesting setup of the PoC session to the SIP/IP core B 332.

In step 309a, upon receipt of the Auto-Answer message, the PoC server (A)-participating & controlling 323 sends an Unconfirmed OK message toward the SIP/EP core A 322. In step 309b, the SIP/EP core B 332 routes the Invite message to the PoC client B 333.

In step 310a, the SIP/IP core A 322 forwards the Unconfirmed OK message to the PoC client A 321. In step 310b, upon receipt of the Invite message, the PoC client B 333 sends an OK message to the SIP/EP core B 332 in response to the Invite message.

In step 311a, the PoC server (A)-participating & controlling 323 sends a Talk Burst Confirm Response message to the PoC client A 321. In step 311b, the SIP/P core B 332 forwards the OK message to the PoC server (B)-participating 331.

In step 312a, the PoC client A 321 sends media to the PoC server (A)-participating & controlling 323. In step 312b, the PoC server (B)-participating 331 forwards the OK message to the SIP/IP core B 332. In step 313b, the SIP/IP core A 322 receives the OK message from the SIP/IP core B 332. In step 314b, the SIP/IP core A 322 sends the OK message to the PoC server (A)-participating & controlling 323. In step 315, the PoC server. (A)-participating & controlling 323 sends the received Talk Burst Indication to the PoC server (B)-participating 331. In step 316, the PoC server (B)-participating 331 relays the received Talk Burst message to the PoC client B 333.

FIG. 4 is a diagram illustrating a configuration of an IMS-based PTT service network.;

Referring to FIG. 4, the IMS-based PTT service network includes a UE 400, an XML Document Management Server (XDMS) 415, a presence server 419, a PoC server 417, and an IMS core 410 with a Proxy-Call Session Control Function (P-CSCF) 411 and a Serving-Call Session Control Function (S-CSCF) 413.

The UE 400 serves as a PTT client. The UE 400, if it desires to receive the PTT service, sends an SIP signaling message to the PoC server 417 to receive a media channel allocated thereto. If a PoC session is set up, the UE 400 exchanges packets with the PoC server 417 through a bearer channel set up between the UE 400 and the PoC server 417.

The PoC server 417 takes charge of signaling and bearer handling for the PTT service. The PoC server 417 handles the SIP message transmitted from the UE 400, and sets up a media channel (RTP) between the UE 400 and the PoC server 417. If the media session is set up, the PoC server 417 performs a function of copying and distributing packets for packet transmission to the UE 400. In addition, the PoC server 417 performs floor control during the PTT service, generates billing-related data, and reports the billing information to a billing server.

The XDMS 415 is a server for managing XML documents. The presence server 419 is an entity for relaying the PTT service by performing the functions defined in the ISP standard. The P-CSCF 411 and the S-CSCF 413 are entities for performing a call switching function defined in the IMS network.

A UE-(P-CSCF) interface Gm is an interface for communication, including registration and session control-related processing, between the UE 400 and the IMS core 410, and supports the SIP. A (P-CSCF)-(S-CSCF) interface Mw, which is an interface for communication between CSCFs, performs a function of forwarding a signaling message, and supports the SIP. An (S-CSCF)-(presence server) interface ISC, an interface between the CSCF and the presence server which is an SIP application server, is used for providing the presence service through the IMS core 410. A UE-XDMS interface Ut is an interface for allowing the UE 400 to manage service-related information, including group list and policy information in the XDMS 414. Exemplary management functions include generating, deleting and inquiring.

FIGS. 5A and 5B are diagrams illustrating a call setup process of an IMS-based PTT service network.

Referring to FIGS. 5A and 5B, the conventional IMS-based PTT service network is roughly divided into a network A including a UE-A 530, a PS domain (A) 535, an IMS core (A) 540, and a PoC server (A)-participating & controlling 545, and a network B including a PoC server (B)-participating 550, an IMS core (B) 555, a PS domain (B) 560, and a UE-B 565.

In step 501, a user A of the UE-A 530 pushes a PTT indication/button initiating communication with a user B of the UE-B 565. In step 502, the UE-A 530 sends an Invite message to the IMS core (A) 540 thereby to generate a SIP session for the PoC communication using the UE-B 565 as a destination address. In steps 503 and 504, the IMS core (A) 540 identifies the service indication by evaluating the initial filter criteria and routes the Invite message to the PoC server (A)-participating & controlling 545.

In steps 505 and 506, the PoC server (A)-participating & controlling 545, together with the IMS core (A) 540, forwards the Invite message toward the IMS core (B) 555. In steps 507 and 508, the IMS core (B) 555 identifies the service indication by evaluating the initial filter criteria, and routes the Invite message to the PoC server (B)-participating 550. In step 509a, because the UE-B 565 automatically accepts the session, the PoC server (B)-participating 550 sends an Auto-Answer message to the IMS core (B) 555.

In step 509b, the IMS core (B) 555 forwards the Invite message to the PoC server (B)-participating 550. In steps 510a to 511a, the IMS core (B) 555 forwards the Auto-Answer message toward the the PoC server (A)-participating & controlling 545 via IMS core (A) 540.

In steps 512a to 513a, the PoC server (A)-participating & controlling 545 sends a 200 OK message toward the IMS core (A) 540 based on the Auto-Answer message supporting media buffering, and at the same time, sends a Talk Burst Confirm message to the UE-A 530. In step 514a, if the service based local policy is applied to the network of the UE-A 530, the IMS core (A) 540 generates an authority token for the session, inserts the authority token in an available and reliable SIP Response message, and forwards the SIP Response message to the UE-A-530. In step 515a the IMS core (A) 540 200 OK message to UE-A 530 which returns a ACK to IMS core (A) 540 in step 516a.

In step 517a, after receiving both the 200 OK message and the Talk Burst Confirm message, the UE-A 530 can send media data to the PoC server (A)-participating & controlling 545. Further, in step 518a, UE-A 530 establishes an appropriate PDP context for media. In step 519a, the IMS core (A) 540 sends an ACK to the PoC server (A)-participating & controlling 545. In step 520a, the PoC server (A)-participating & controlling 545 buffers the received media until it receives an ACK from the UE-B 565. The UE-A 530 continues to send media.

In step 510b, for the service based domain policy applied in the network to which the UE-B 565 belongs, the IMS core (B) 555 generates an authority token for the session, inserts the authority token in an Invite message in step 511b, and forwards the Invite message to the UE-B 565 in step 512b.

Typically, the UE-B needs to be paged in step 535 before the Invite message is modified. The Invite message in step 511b is forwarded to the PS domain without a functional modification.

In step 513b, after receiving the Invite message, the UE-B 565 accepts the session by returning a 200 OK message. In step 514b, the UE-B 565 establishes an appropriate PDP context for media. Further, the UE-B 565 can perform additional setting for media and talk burst control including traffic class streaming and bandwidth for negotiable media parameters, through an exchange of IP address and APN.

In step 515b, the IMS core (B) 555 forwards the 200 OK message to the PoC server (B)-participating 550. In step 516b, the PoC server (B)-participating 550 forwards the 200 OK message back to IMS core (B) 555 which then forwards the 200 OK message toward the IMS core (A) 540 in step 517b. In step 518b, the IMS core (A) 540 forwards the 200 OK message toward the PoC server (A)-participating & controlling 545.

In steps 521, the PoC server (A)-participating & controlling 545 sends an ACK for the session setup to IMS core (A) 540. In step 536, the PoC server (A)-participating & controlling 545 sends a talk burst to the UE-B 565. In step 522 the ACK is forwarded to the IMS core (B) 555. In step 523, the ACK is then forwarded to the PoC server (B)-participating 550.

In steps 524, the PoC server (B)-participating 550 sends the ACK for the session to the IMS core (B) 555 which in step 525 send the ACK to UE-B 565. In step 531, the media transmitted from the UE-A 530 to the PoC server (A)-participating & controlling 545 and is buffered therein. In step 532, the media is sent from the PoC server (A)-participating & controlling 545 to the PoC server (B)-participating 550. In the step 533, the PoC server (B)-participating 550 sends the media to the UE-B 565.

In the foregoing conventional PTT service, only the current active user having the floor can send media, and the other users can only receive the media. That is, the PTT service, which is a unidirectional communication service, cannot allow several users to simultaneously send or receive media.

Accordingly, there is a need for a service that can allow several users to simultaneously send or receive media.

### SUMMARY OF THE INVENTION

Exemplary embodiments of the present invention address at least the above problems and/or disadvantages and provide at least the advantages described below. Accordingly, an aspect of an exemplary embodiment of the present invention is to provide a method and system in which users using a PTT service can switch over from the PTT service to a conference service at the request of a user.

It is another aspect of an exemplary embodiment of the present invention to provide a method and system capable of switching over from unidirectional communication to bidirectional communication at the request of a user during a PTT session by compensating for the unidirectional communication, thereby overcoming a limitation of the conventional PTT service.

According to one aspect of an exemplary embodiment of the present invention, there is provided a method for providing push-to-talk (PTT) so as to conference between a plurality of user equipments (UEs) serving as clients in a mobile communication network including a PTT over cellular (PoC) server, a conference server, and a mixer for mixing for the conference. The method comprises the steps of: performing a request procedure for switching over to the conference during a PoC session between the UEs; performing a conference client invitation or participation procedure for opening a conference session through the conference server; and performing a procedure for releasing the conference session between the PoC server and the UEs.

According to another aspect of an exemplary embodiment of the present invention, there is provided a system for providing push-to-talk (PTT) so as to conference through a mobile communication network between a plurality of clients. The system comprises a PTT over cellular (Poc) server for performing signaling and bearer handling for a PTT service, signaling for PTT to conference switchover, and bearer setup between the client and a mixer for media processing for the conference; the mixer for performing a media mixing function for the conference service, and allocating media resources to the client; a conference server for processing signaling for the conference, and interworking with the mixer to allocate a media channel for the client; and a plurality of user equipment (UE) that each serve as one of the plurality of clients.

According to further another aspect of an exemplary embodiment of the present invention, there is provided a user equipment.(UE) equipped with a client for providing push-to-talk (PTT) so as to conference in a mobile communication network. The UE comprises a PTT service unit for processing a function of the client on the basis of a main control task of a real-time operating system; and constituent elements in a physical layer and a medium access control (MAC) layer, for performing communication in association with the PTT service unit.

According to yet another aspect of an exemplary embodiment of the present invention, there is provided a method for switching over a unidirectional communication mode to a bidirectional communication mode during a push-to-talk (PTT) session between a plurality of user equipments (UEs) serving as clients in a mobile communication network including a PTT over cellular (PoC) server. The method comprises the steps of: sending, by one of the UEs, a message for requesting bidirectional communication to the PoC server; switching over, by the PoC server, the unidirectional communication mode to the bidirectional communication mode using a mixing function; and sending, by the PoC server, an indication for enabling all PoC clients to simultaneously talk to the UE, which is a PoC client, through a preset real-time transport protocol (RTP) channel.

According to still another aspect of an exemplary embodiment of the present invention, there is provided a system for switching over a unidirectional communication mode to a bidirectional communication mode during a push-to-talk (PTT) session between a plurality of clients through a mobile communication network. The system comprises a PTT over cellular (PoC) server for performing signaling and bearer handling for a PTT service, and performing signaling for switching over the unidirectional communication mode to the bidirectional communication mode during the PTT session; and a user equipment (UE) that serves as the client.

According to still another aspect of an exemplary embodiment of the present invention, there is provided a user equipment (UE) equipped with a client for switching over a unidirectional communication mode to a bidirectional communication mode during a push-to-talk (PTT) session in a mobile communication network. The UE comprises a PTT service unit for processing a function of the client on the basis of a main control task of a real-time operating system; and constituent elements in a physical layer and a medium access control (MAC) layer, for performing communication in association with the PTT service unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a conceptual diagram of a PTT service network for the conventional PTT service;

FIG. 2 is a diagram illustrating a configuration of an OMA-based PTT service network;

FIG. 3 is a diagram illustrating a call setup process for an IMS-based PTT service;

FIG. 4 is a diagram illustrating a configuration of an IMS-based PTT service network;

FIGS. 5A and 5B are diagrams illustrating a call setup process of an IMS-based PTT service network;

FIG. 6 is a diagram illustrating a configuration of a network capable of providing a PTT so as to conference according to an exemplary embodiment of the present invention;

FIG. 7 is a diagram illustrating a PTT to conference switchover scenario according to an exemplary embodiment of the present invention;

FIGS. 8A and 8B are diagrams illustrating a call setup process in the scenario of FIG. 7 according to an exemplary embodiment of the present invention;

FIG. 9 is a diagram illustrating a PTT to conference switchover scenario according to another exemplary embodiment of the present invention;

FIGS. 10A and 10B are diagrams illustrating a call setup process in the scenario of FIG. 9 according to another exemplary embodiment of the present invention;

FIG. 11 is a diagram illustrating a scenario for switching a unidirectional communication mode to a bidirectional communication mode during a PTT session according to a further exemplary embodiment of the present invention;

FIG. 12 is a diagram illustrating a call setup process in the scenario of FIG. 11 according to another exemplary embodiment of the present invention;

FIG. 13 is a diagram illustrating a scenario for switching a unidirectional communication mode to a bidirectional communication mode during a PTT session according to yet another exemplary embodiment of the present invention;

FIG. 14 is a diagram illustrating a call setup process in the scenario of FIG. 13 according to another exemplary embodiment of the present invention; and

FIG. 15 is a block diagram illustrating a structure of a UE capable of performing PTT so as to conference according to an exemplary embodiment of the present invention.

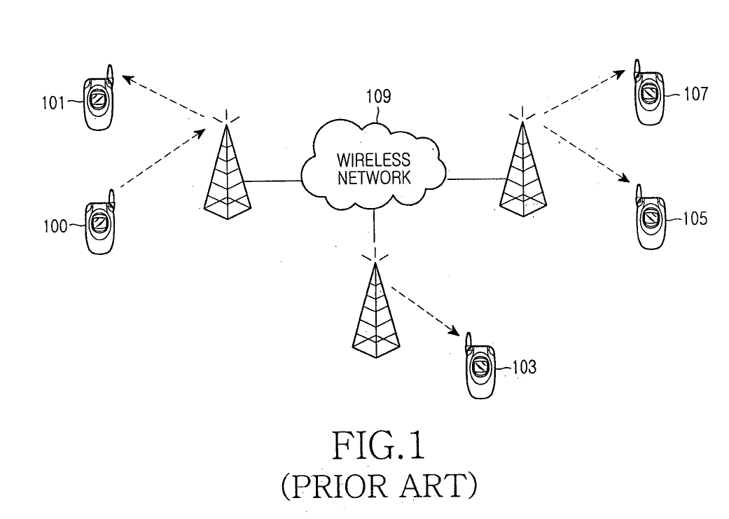

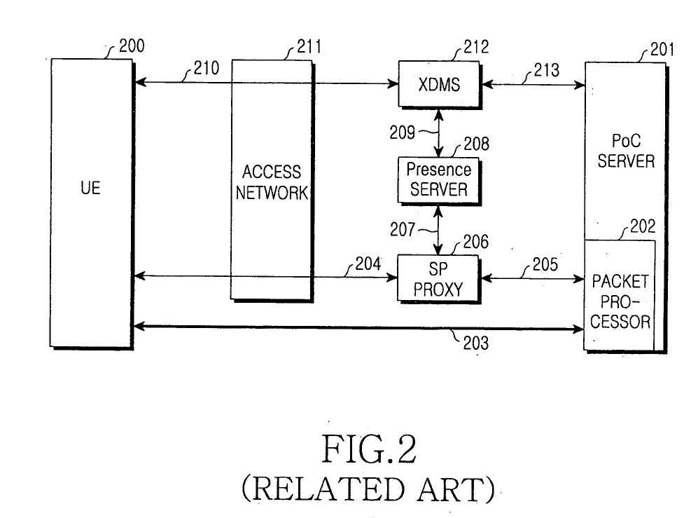

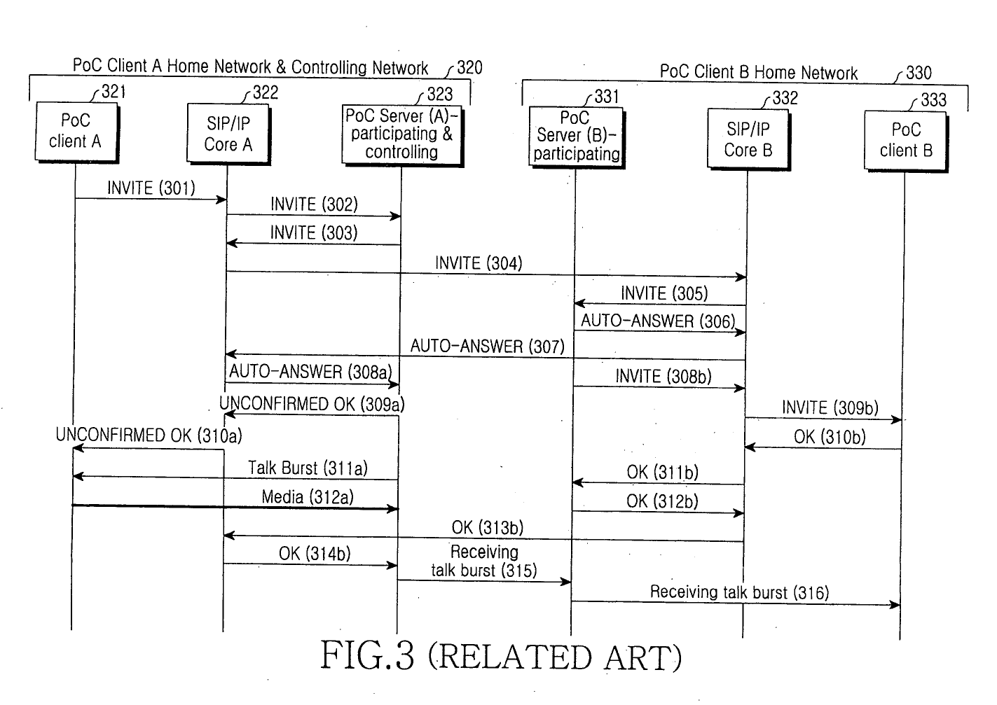

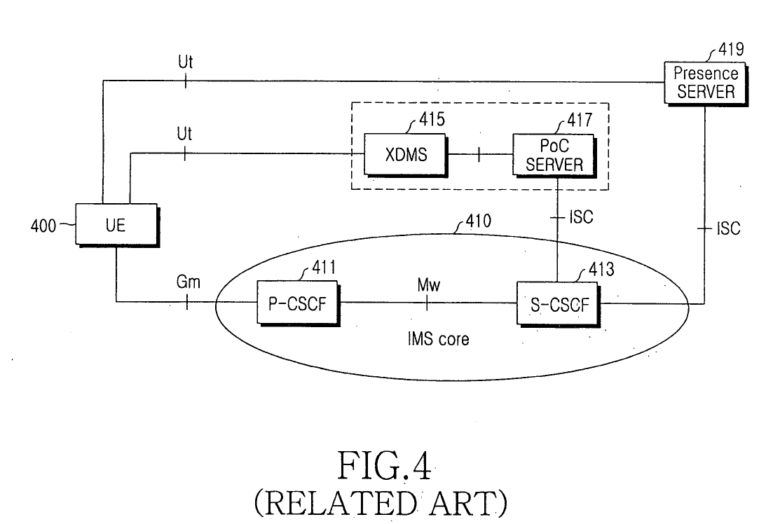

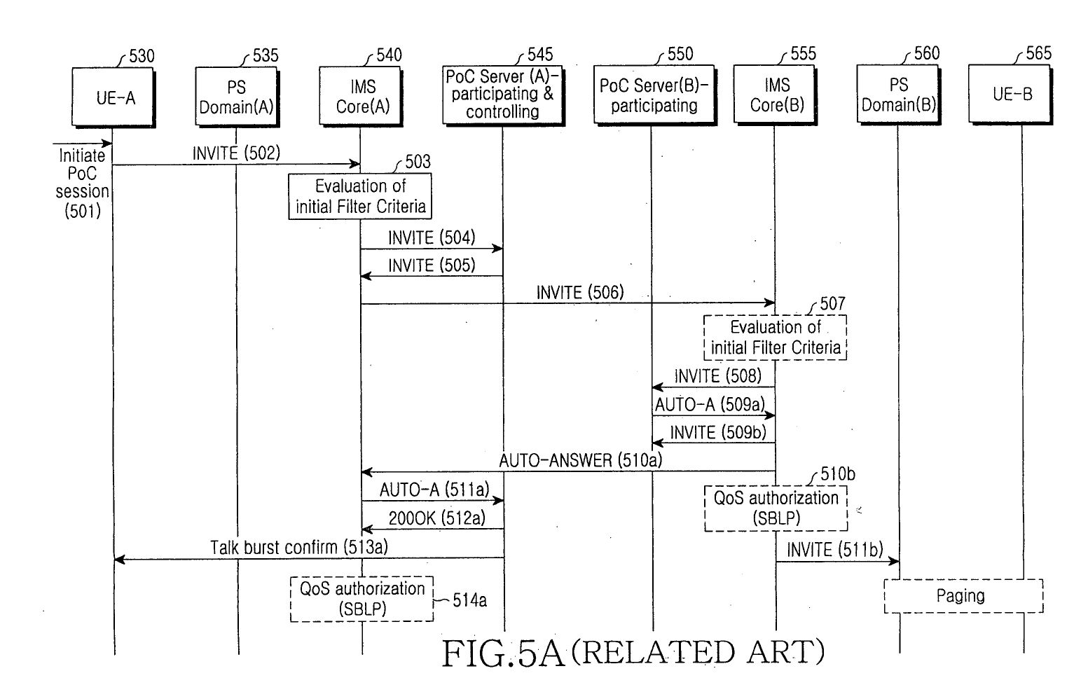

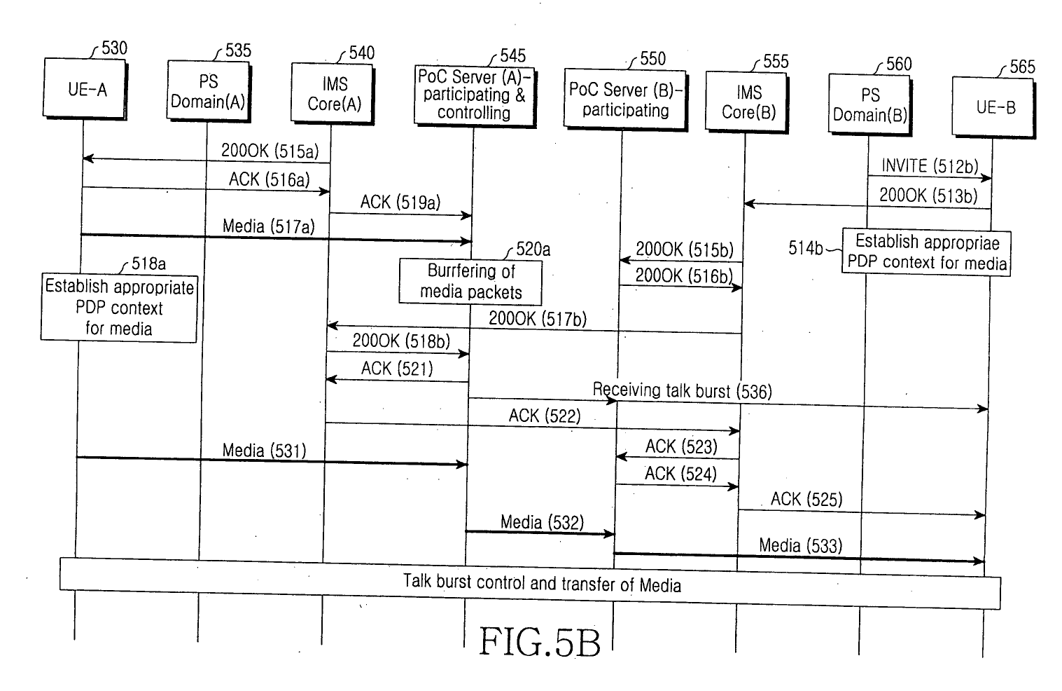

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In the group PTT service, several users are able to listen to voice content made by another user using their own terminals, thereby overcoming the 1:1 call restriction of conventional communications services. The PTT service can define middle/small-scale groups, to perform voice transmission and support 1:1 walkie-talkie calls. The network can be configured as follows to switch over to the conference service during the PTT service.

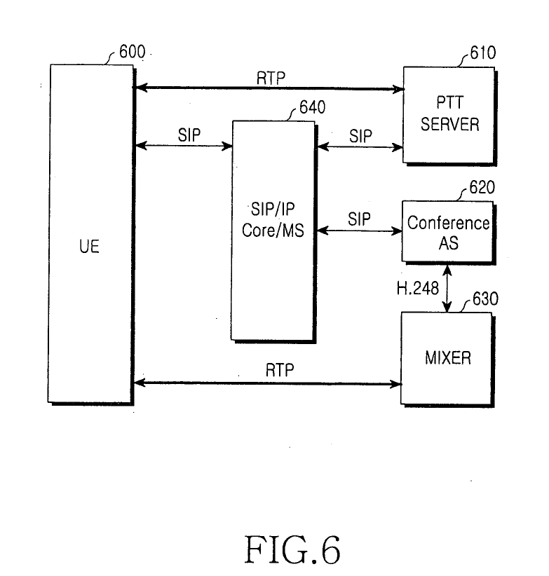

FIG. 6 is a diagram illustrating a configuration of a network capable of providing a PTT to conference switchover according to an exemplary embodiment of the present invention.

Referring to FIG. 6, the network configuration capable of supporting the PTT to conference includes a UE 600, a PoC server 610, a conference server 620, a mixer 630, and an SIP/IP core (IMS) 640.

The UE 600 serves as a PTT client. To switch over from the PTT service to the conference service during PoC session, the UE 600 performs a function of transmitting SIP signaling for the switchover to the PoC server 610. The UE 600 sets up a RTP bearer channel to the PoC server 610 for the PTT service, sets up a RTP bearer channel to the mixer 630 for the conference service, and exchanges packets over the set bearer channel.

The PoC server 610 takes charge of signaling and bearer handling for the PTT service. In addition, the PoC server 610 handles signaling for PTT to conference. Upon receipt of an SIP message for PTT to conference switchover from the UE 600, the PoC server 610 sends an SIP message including media information for the participants to the related conference server. Further, the PoC server 610 performs a function of generating billing-related data and reporting the billing data to a billing server. The PoC server 610 controls on conferencing. The PoC server 610, otherwise known as the conference control logic, performs bearer setup between the conference participant and the mixer 630 for media processing for the conference. Media processing includes mixing, bridging, or the like.

The conference server 620 takes charge of the signaling processing for the conference service. Upon receipt of an SIP message including media information for all participants participating in the PoC session from the PoC server, the conference server 620 sets up a conference session to each participant using the received media information. The conference server 620 interworks with the mixer 630 using a H.248/Megaco protocol to allocate a media channel for each participant. In addition, the conference server 620 performs a function of generating billing-related data and reporting the billing data to the billing server.

The mixer 630 performs a media mixing function for the conference service. Further, the mixer 630 allocates media resources to the UE 600 through H.248/Megaco interworking with the conference server 620. After a PoC session is setup, the PoC server 610 switches over from the PoC session to the conference session at the request of the PTT participant. Next, a description will be made of a PTT to conference switchover scenario.

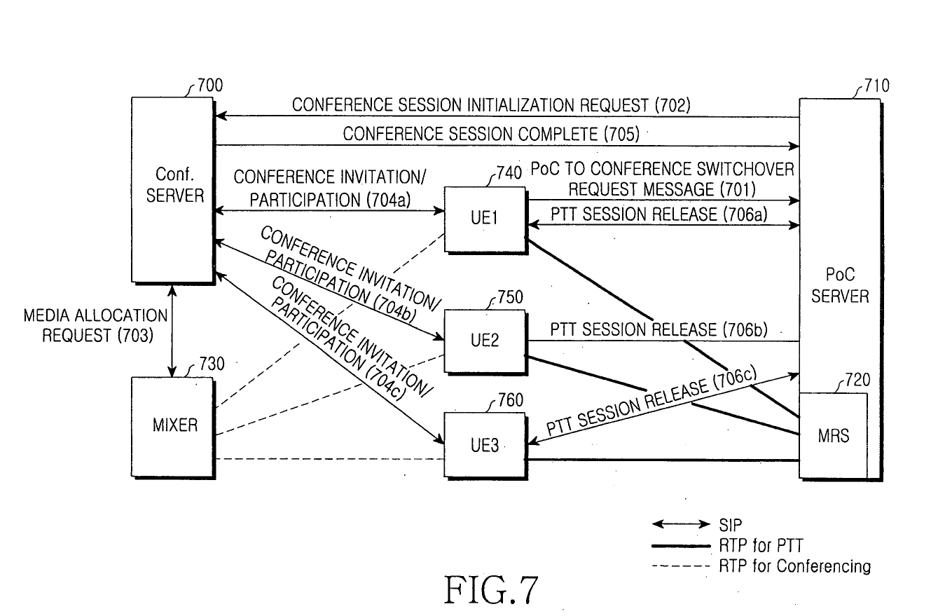

FIG. 7 is a diagram illustrating a PTT to conference switchover scenario according to an exemplary embodiment of the present invention.

Referring to FIG. 7, the PTT to conference switchover scenario includes a request procedure for PTT to conference, a conference participant invitation/participation procedure for opening a conference session, and a procedure for releasing an old PoC session by a PoC server, between a conference server 700, a PoC server 710 with a Media Relay Server (MRS) 720, a mixer 730, and a plurality of UEs 740, 750 and 760.

Request Procedure for PTT to Conference

In step 701, the UE1 740 sends an SIP message, such as aPTT to conference switchover indication, for a PTT to conference switchover to the PoC server 710. In step 702, the PoC server 710 sends a Conference Session Initialization message to the conference server 700. In this case, the PoC server 710 sends, to the conference server 700, uniform resource identifiers (URIs) and media information, such as RTP port, codec, or the like, for the participants that is used during a corresponding PoC session,. The PoC server 710 informs each PTT client that the PoC session is switched to the conference, using information broadcasting. In step 703, the conference server 700 sends the media information received from the PoC server 710 to the mixer 730 that performs mixing for the conference, and the mixer 730 allocates media for the conference participants using the corresponding information.

Conference Participant Invitation/Participation Procedure for Opening Conference Session

In steps 704a-704c, the conference server 700 sends a Conference Invite message, including media information allocated in the mixer, to each participant in order to set up a conference session. In step 705, after the invitation/participation to each participant is completed, the conference server 700 informs the PoC server 710 of the expiration of the conference session. At this point, the conference server 700 informs the participants of the setup of the conference using information broadcasting.

Procedure for Releasing Old PoC Session by PoC Server

In steps 706a-706b, after receiving the information indicating the completion of the conference setup from the conference server 700, the PoC server 710 performs a PoC session release procedure for releasing the old PoC session.

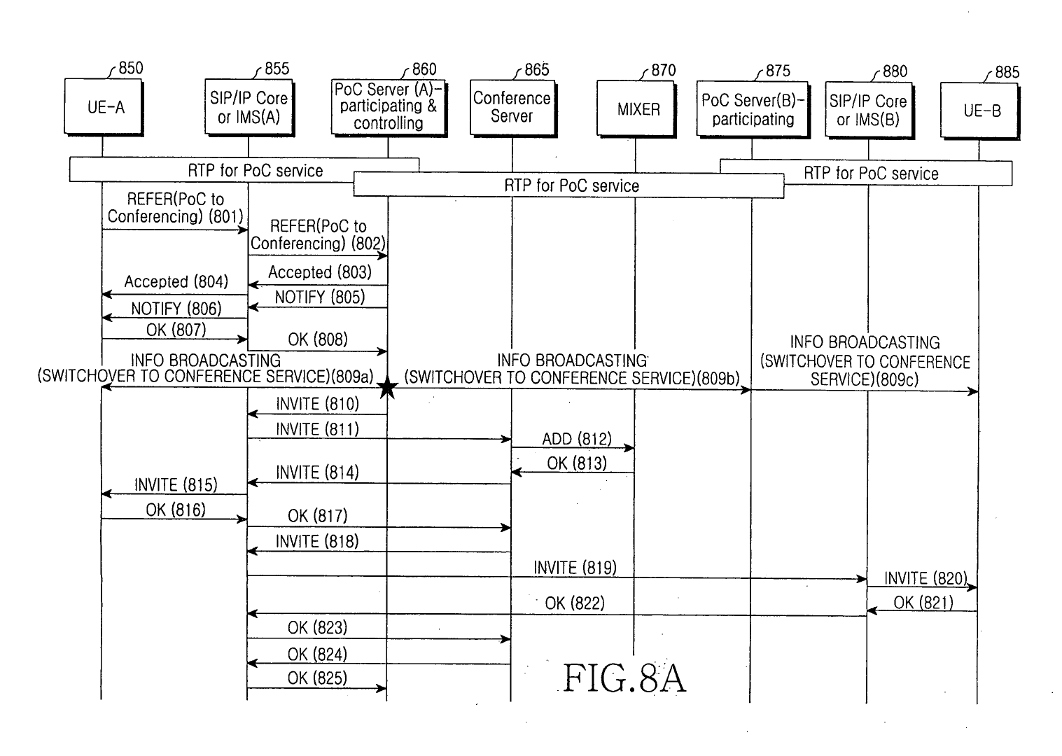

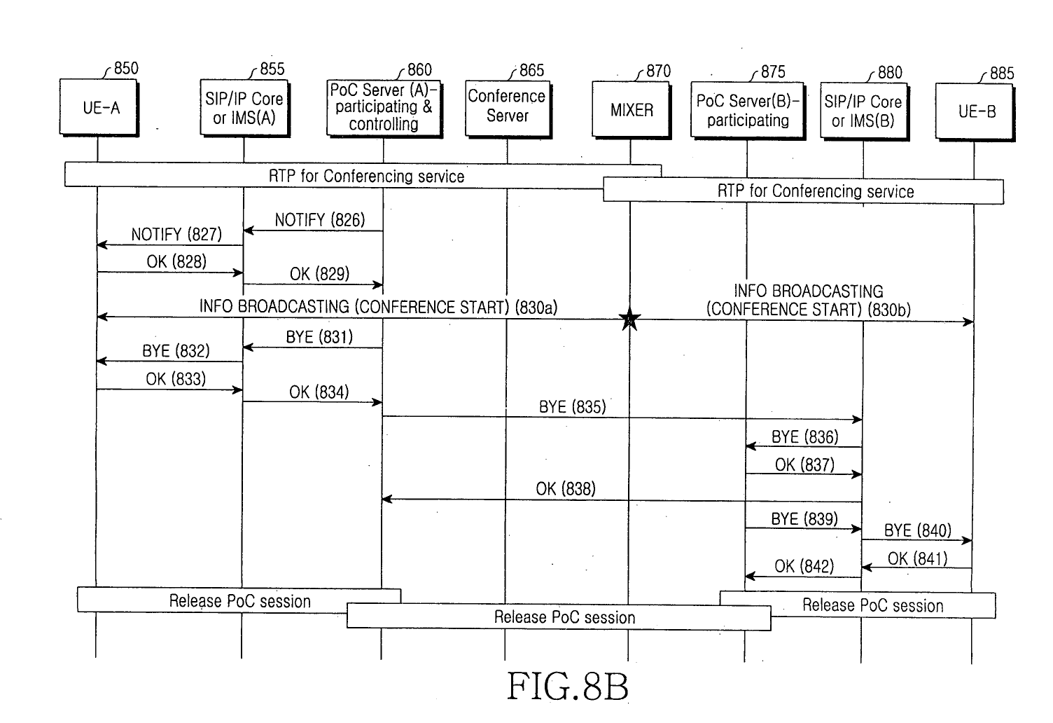

FIGS. 8A and 8B are diagrams illustrating a call setup process in the scenario of FIG. 7 according to an exemplary embodiment of the present invention.

Referring to FIGS. 8A and 8B, in step 801, a UE-A 850 sends a Refer message for PoC to conference to an SIP/IP core (A) 855 in the state where an RTP bearer channel for the PoC service is set up. In step 802, the SIP/IP core (A) 855 forwards the Refer message to a PoC server (A)-participating & controlling 860. In step 803, the PoC server (A)-participating & controlling 860 sends an Accepted message to the SIP/IP core (A) 855. In step 804, the SIP/IP core (A) 855 forwards the Accepted message to the UE-A 850.

In steps 805 to 808, the PoC server (A)-participating & controlling 860 sends a Notify message to the UE-A 850 via the SIP/IP core (A) 855, and receives an OK message from the UE-A 850 via the SIP/IP core (A) 855.

In steps 809a to 809c, the PoC server (A)-participating & controlling 860 broadcasts the information indicating the ongoing switchover to the conference service. In step 810, the PoC server (A)-participating & controlling 860 sends an Invite message to the SIP/IP core (A) 855. In step 811, the SIP/IP core (A) 855 sends an Invite message to a conference server 865. In steps 812 and 813, the conference server 865 sends an Add message to a mixer 870, and receives an OK message from the mixer 870.

In steps 814 to 817, the conference server 865 sends an Invite message and receives an OK message via the SIP/IP core (A) 855. In step 818, the conference server 865 sends an Invite message to the SIP/IP core (A) 855. In steps 819 to 822, the SIP/EP core (A) 855 sends an Invite message to a UE-B 885 via an SIP/IP core (B) 880, and receives an OK message from the UE-B 885 via the SIP/IP core (B) 880. In steps 823 to 825, the SIP/EP core (A) 855 exchanges OK messages with the conference server 865, and sends again an OK message to the PoC server (A)-participating & controlling 860. Thereafter, an RTP session for the conference service is set up.

In steps 826 to 829, the PoC server (A)-participating & controlling 860 sends a Notify message to the UE-A 850 via the SIP/IP core (A) 855, and receives an OK message from the UE-A 850 via the SIP/IP core (A) 855. In steps 830a and 830b, the mixer 870 broadcasts the information indicating the start of the conference. In steps 831 to 834, the PoC server (A)-participating & controlling 860 sends a Bye message to the UE-A 850 via the SIP/EP core (A) 855, and receives an OK message from the UE-A 850 via the SIP/IP core (A) 855.

In steps 835 to 838, the PoC server (A)-participating & controlling 860 sends a Bye message to a PoC server (B)-participating 875 via the SIP/IP core (B) 880, and receives an OK message from the PoC server (B)-participating 875 via the SIP/EP core (B) 880. In steps 839 to 842, the PoC server (B)-participating 875 sends a Bye message to the UE-B 885 via the SIP/IP core (B) 880, and receives an OK message from the UE-B 885 via the SIP/IP core (B) 880, releasing the PoC session.

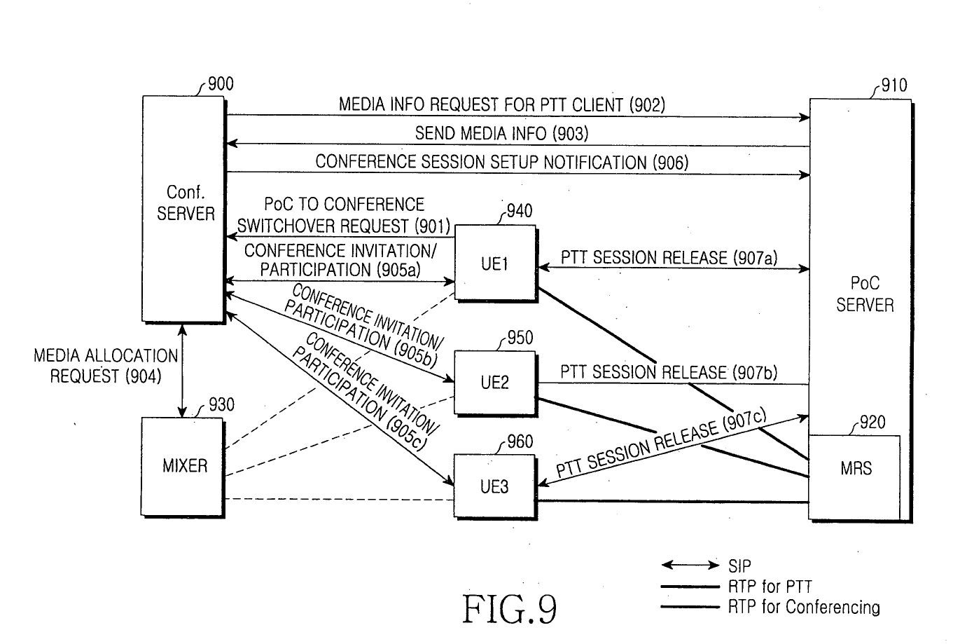

FIG. 9 is a diagram illustrating a PTT to conference switchover scenario according to another exemplary embodiment of the present invention.

Referring to FIG. 9, the PTT to conference switchover scenario includes a request procedure for a PTT to conference switchover, a conference participant invitation/participation procedure for opening a conference session, and a procedure for releasing an old PoC session by a PoC server, between a conference server 900, a PoC server 910 with a Media Relay Server (MRS) 920, a mixer 930, and a plurality of UEs 940, 950 and 960.

Request Procedure for PTT to Conference

In step 901, the UE1 940 sends an SIP message, including a PTT to conference switchover indication for PTT to conference switchover, to the conference server 900. In step 902, the conference server 900 sends a message for requesting the media information used during the old PoC session to the PoC server 910 to acquire media information necessary for setting up a conference session. In step 903, the PoC server 910 sends URIs and media information (RTP port, codec, etc.) for the participants, used during the corresponding PoC session, to the conference server 900. The media information includes RTP port, codec, or the like. At this point, the PoC server 910 informs each PTT client that the PoC session is switched to the conference, using information broadcasting. In step 904, the conference server 900 sends the media information received from the PoC server 910 to the mixer 930 that performs mixing for the conference, and the mixer 930 allocates media for the conference participants using the corresponding information.

Conference Participant Invitation/Participation Procedure for Opening Conference Session

In steps 905a-906c, the conference server 900 sends a Conference Invite message, including media information allocated in the mixer, to each participant to set up a conference session. In step 906, after the invitation/participation to each participant is completed, the conference server 900 informs the PoC server 910 of the expiration of the conference session. At this point, the conference server 900 informs the participants of the setup of the conference using information broadcasting.

Procedure for Releasing Old PoC Session by PoC Server

In steps 907a-907c, after receiving the information indicating the completion of the conference setup from the conference server 900, the PoC server 910 performs a PoC session release procedure for releasing the old PoC session.

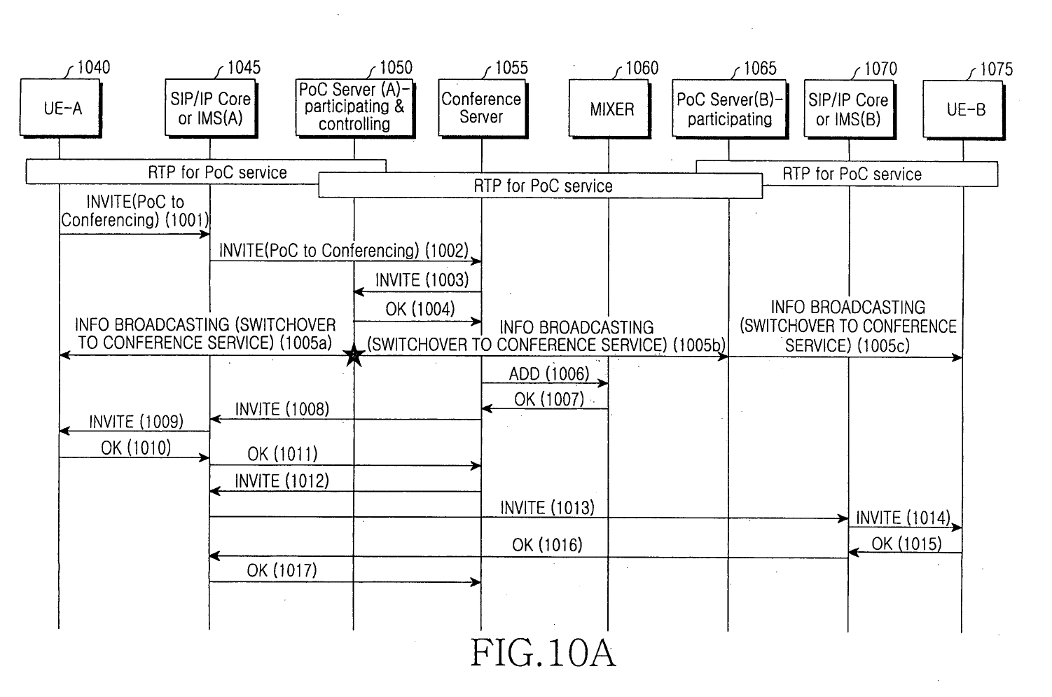

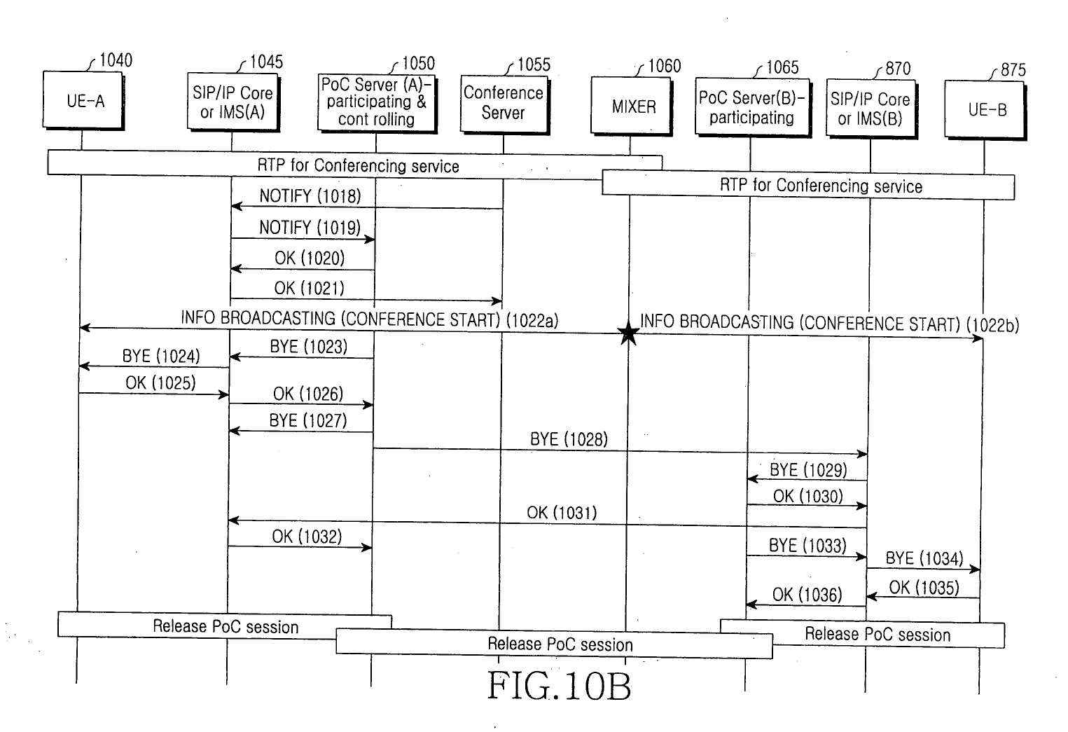

FIGS. 10A and 10B are diagrams illustrating a call setup process in the scenario of FIG. 9 according to another exemplary embodiment of the present invention.

Referring to FIGS. 10A and 10B, in step 1001, a UE-A 1040 sends an Invite message for PoC so as to conference to an SIP/IP core (A) 1045 in the state where an RTP session for the PoC service is set up. In step 1002, the SIP/IP core (A) 1045 forwards the Invite message to a conference server 1055. In step 1003, a PoC server (A)-participating & controlling 1050 receives an Invite message from the conference server 1055. In step 1004, the PoC server (A)-participating & controlling 1050 sends an OK message to the conference server 1055.

In steps 1005a to 1005c, the PoC server (A)-participating & controlling 1050 broadcasts the information indicating the ongoing switchover to the conference service. In step 1006, the conference server 1055 sends an Add message to a mixer 1060. In step 1007, the conference server 1055 receives an OK message from the mixer 1060. In step 1008, the conference server 1055 sends an Invite message to the SIP/IP core (A) 1045.

In steps 1009 and 1010, the SIP/IP core (A) 1045 sends an Invite message to the UE-A 1040 and receives an OK message from the UE-A 1040. In step 1011, the SIP/IP core (A) 1045 sends an OK message to the conference server 1055. In step 1012, the SIP/IP core (A) 1045 receives an Invite message from the conference server 1055.

In step 1013, the SIP/EP core (A) 1045 sends an Invite message to the SIP/IP core (B) 1070. In step 1014, the SIP/IP core (B) 1070 sends an Invite message to a UE-B 1075. In step 1015, the SIP/IP core (B) 1070 receives an OK message from the UE-B 1075. In step 1016, the SIP/IP core (A) 1045 receives an OK message from the UE-B 1075. In step 1017, the conference server 1055 receives an OK message from the SIP/IP core (A) 1045. In this context, an RTP session for the conference service is set up.

In step 1018, the SIP/IP core (A) 1045 receives a Notify message from the conference server 1055. In steps 1019 and 1020, the SIP/IP core (A) 1045 sends a Notify message to the PoC server (A)-participating & controlling 1050 and receives an OK message from the PoC server (A)-participating & controlling 1050. In step 1021, the SIP/IP core (A) 1045 sends an OK message to the conference server 1055.

In steps 1022a and 1022b, the mixer 1060 broadcasts the information indicating the start of the conference. In steps 1023 to 1026, the UE-A 1040 receives a Bye message from the PoC server (A)-participating & controlling 1050 via the SIP/IP core (A) 1045, and sends an OK message to the PoC server (A)-participating & controlling 1050 via the SIP/IP core (A) 1045.

In steps 1027 and 1028, the PoC server (A)-participating & controlling 1050 sends a Bye message to the SIP/IP core (A) 1045 and the SIP/IP core (B) 1070.

In steps 1029 and 1030, the SIP/IP core (B) 1070 sends a Bye message to a PoC server (B)-participating 1065, and receives an OK message from the PoC server (B)-participating 1065; In step 1031, the SIP/IP core (B) 1070 sends an OK message to the SIP/IP core (A) 1045. In step 1032, the SIP/IP core (A) 1045 sends an OK message to the PoC server (A)-participating & controlling 1050. In steps 1033 to 1036, the PoC server (B)-participating 1065 sends a Bye message to the UE-B 1075 via the SIP/IP core (B) 1070, and receives an OK message from the UE-B 1075 via the SIP/IP core (B) 1070. Thereafter, the PoC session is released.

Next, a description will be made of 2 scenarios for switching the PoC session, including switching a unidirectional communication to bidirectional communication.

A brief procedure will be described below. After a PTT session is setup, a PoC server switches PTT communication, which has been performed in a unidirectional manner, to bidirectional communication, at the request of a PTT participant. The PoC server switches the existing unidirectional PTT communication to bidirectional communication using floor control signaling that guarantees only one participant to talk for a predetermined time. For media processing, including media mixing or bridging, for the bidirectional communication, the PoC server performs a media mixing function.

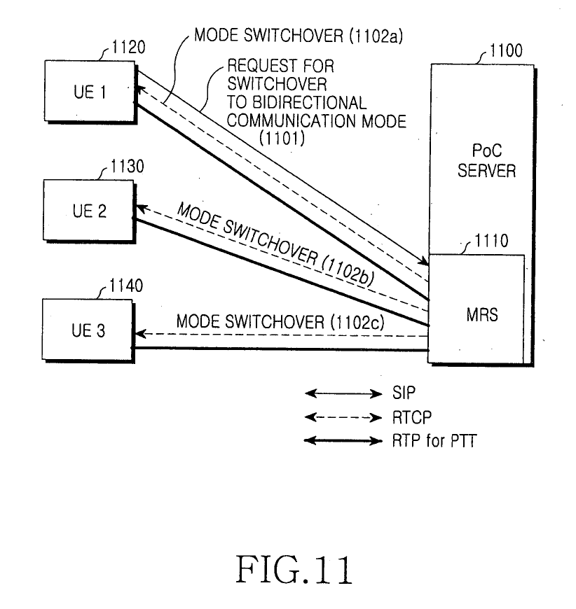

FIG. 11 is a diagram illustrating a scenario for switching a unidirectional communication mode to a bidirectional communication mode during a PTT session according to further another exemplary embodiment of the present invention.

Referring to FIG. 11, in step 1101, a UE1 1120 sends an SIP message for requesting bidirectional communication to a PoC server 1100. In steps 1102a to 1102c, the PoC server 1100 switches a unidirectional communication mode to a bidirectional communication mode using a mixing function in its MRS 1110. The PoC server 1100 sends an indication of the switchover to the UE1 to a UE3 1120, 1130 and 1140, which are PoC clients. The indication is sent through a predetermined RTP channel so that all of the PoC clients may simultaneously talk. In this context, the PoC server 1100 broadcasts the information indicating the possibility of the bidirectional communication, to the PoC clients, UE1 to UE3 1120, 1130 and 1140.

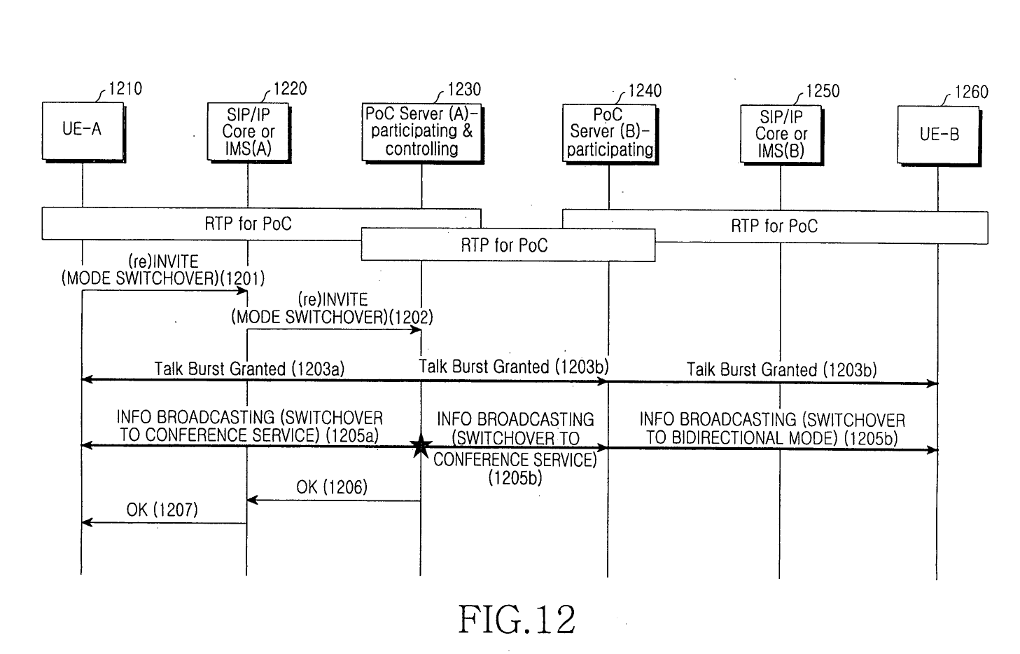

FIG. 12 is a diagram illustrating a call setup process in the scenario of FIG. 11 according to further another exemplary embodiment of the present invention.

Referring to FIG. 12, in step 1201, a UE-A 1210 sends an Invite or reInvite message for switchover of a communication mode to an SIP/EP core (A) 1220 in the state where an RTP session for the PoC service is setup. In step 1202, the SIP/IP core (A) 1220 forwards the Invite or reInvite message to a PoC server (A)-participating & controlling 1230. In steps 1203a and 1203b, the PoC server (A)-participating & controlling 1230 sends a Talk Burst Granted message to the UE-A 1210 and sends the Talk Burst Granted message to a UE-B 1260 via a PoC server (B)-participating 1240. In this case, the PoC server (B)-participating 1240 merely performs a general procedure. Further, SIP/IP core (B) 1250 does not need to be communicated with.

In steps 1205a and 1205b, the PoC server (A)-participating & controlling 1230 broadcasts the information indicating the ongoing switchover to the bidirectional communication mode, to the UE-A 1210 and to the UE-B 1260 via the PoC server (B)-participating 1240. In step 1206, the PoC server (A)-participating & controlling 1230 sends an OK message to the SIP/IP core (A) 1220. In step 1207, the SIP/IP core (A) 1220 sends an OK message to the UE-A 1210.

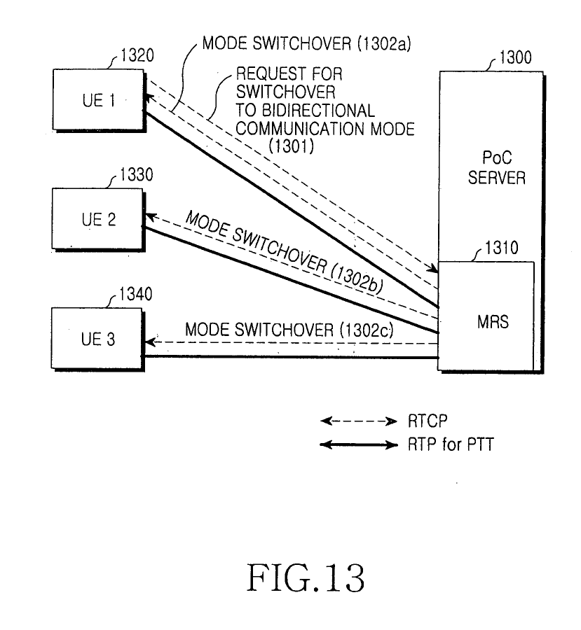

FIG. 13 is a diagram illustrating a scenario for switching a unidirectional communication mode to a bidirectional communication mode during a PTT session according to yet another exemplary embodiment of the present invention.

Referring to FIG. 13, in step 1301, a UE1 1320 sends an RTCP message for requesting bidirectional communication to a PoC server 1300. In steps 1302a to 1302c, the PoC server 1300 switches a bidirectional communication mode to a unidirectional communication mode using a mixing function in its MRS 1310. The PoC server 1300 sends indication to the UE1 to a UE3 1320, 1330 and 1340, which are PoC clients, through a predetermined RTP channel so that all of the PoC clients may simultaneously talk. In this context, the PoC server 1300 broadcasts the information indicating the possibility of the bidirectional communication, to the PoC clients, UE1 to UE3 1320, 1330 and 1340.

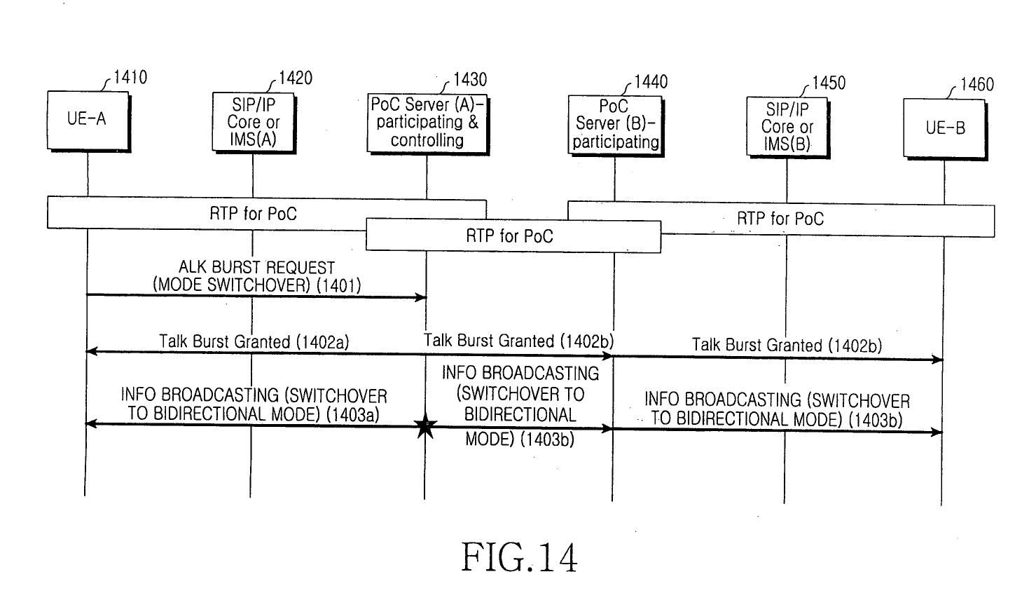

FIG. 14 is a diagram illustrating a call setup process in the scenario of FIG. 13 according to yet another exemplary embodiment of the present invention.

Referring to FIG. 14, in step 1401, a UE-A 1410 sends a Talk Bust Request message for switchover of a communication mode to a PoC server (A)-participating & controlling 1430 in the state in the state where an RTP session for the PoC service is setup. In steps 1402a and 1402b, the PoC server (A)-participating & controlling 1430 sends a Talk Burst Granted message to the UE-A 1410, and sends the Talk Burst Granted message to a UE-B 1460 via a PoC server (B)-participating 1440. In this case, the PoC server (B)-participating 1440 performs a general procedure for the PTT service.

In steps 1403a and 1403b, the PoC server (A)-participating & controlling 1430 broadcasts the information indicating the ongoing switchover to the bidirectional communication, to the UE-A 1410, and to the UE-B 1460 via the PoC server (B)-participating 1440. Here, neither SIP/IP core (A) 1420 nor SIP/IP core (B) 1450 needs to be communicated with.

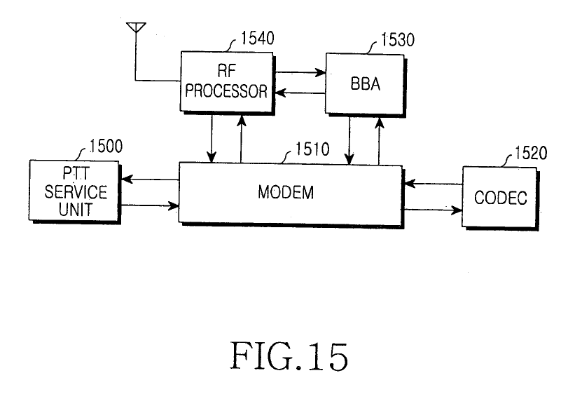

FIG. 15 is a block diagram illustrating a structure of a User Equipment (UE) capable of performing PTT so as to conference according to an exemplary embodiment of the present invention.

Referring to FIG. 15, the UE includes a PTT service unit 1500, a modem 1510, a codec 1520, a Baseband Analog (BBA) 1530, and a radio frequency (RF) processor 1540. The PTT service unit 1500 processes the PTT to conference function described in FIGS. 6 to 14 by software, on the basis of a main control task in the real-time operating system.

The modem 1510, the codec 1520, the BBA 1530, and the RF processor 1540 follow the communication procedure of the general UE, and only the special functions thereof will be introduced below. The modem 1510 processes a protocol defined in, for example, the IS-95A standard. The IS-95A standard is hereby incorporated by reference. The codec 1520 generally adopts one of a 8 kbps Qualcomm Code Excited Linear Prediction (QCELP) and a 8 kbps Enhanced Variable Rate Codec (EVRC). The BBA 1530 is formed as an integrated circuit, and includes a secondary intermediate frequency processor, an analog-to-digital (A/D) converter, and a digital-to-analog (D/A) converter. The RF processor 1540 processes the high frequency and the intermediate frequency.

As can be understood from the foregoing description, exemplary embodiments of the present invention can switch over to a conference service during a PTT service without newly initializing the conference service after completing the old PoC session.

In addition, exemplary embodiments of the present invention can switch over to bidirectional communication between all or some participants during a PoC session which is a unidirectional communication.

Moreover, exemplary embodiments of the present invention can switch over from unidirectional transmission to bidirectional transmission at the request of a user during a PTT session, by compensating the bidirectional communication thereby overcoming a limitation of the conventional PTT service.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for providing push-to-talk (PTT) so as to conference between a plurality of user equipment (UEs) serving as clients in a mobile communication network, the mobile communication network comprising a PTT over cellular (PoC) server, a conference server, and a mixer for mixing for the conference, the method comprising the steps of:
performing a request procedure for switching over to the conference during a PoC session between the UEs;
performing a conference client invitation or participation procedure for opening a conference session through the conference server; and
performing a procedure for releasing the conference session between the PoC server and the UEs.

2. The method of claim 1, wherein the step of performing a request procedure comprises the steps of:
sending a conference switchover indication message from a UE desiring the conference to the PoC server, the UE desiring the conference being one of the plurality of UEs;
sending, by the PoC server, a conference session initialization message to the conference server; and
sending, by the conference server, media information received from the PoC server to the mixer, and allocating, by the mixer, media for a conference client using the media information.

3. The method of claim 2, wherein the PoC server sends uniform resource identifiers (URIs) and media information for the clients, used during the PoC session, to the conference server in the process of sending the conference session initialization message to the conference server.

4. The method of claim 3, wherein the media information includes a real-time transport protocol (RTP) port and a codec.

5. The method of claim 3, wherein after sending the URIs and the media information for the clients used during the PoC session, the PoC server sends to each of the clients a notification indicating that the PoC session is switched to the conference.

6. The method of claim 1, wherein the step of performing the conference client invitation or participation procedure comprises the steps of:
sending, by the conference server, a conference invite message including media information allocated in the mixer to each of the clients to set up a conference session; and
sending, by the conference server, a notification indicating expiration of the conference session to the PoC server.

7. The method of claim 6, wherein after sending the notification indicating the expiration of the conference session to the PoC server, the conference server sends the clients a notification indicating setup of the conference.

8. The method of claim 1, wherein the step of performing a procedure for releasing the conference session comprises the step of releasing, by the PoC server, the PoC session upon receiving a notification indicating completed setup of the conference from the conference server.

9. The method of claim 1, wherein the step of performing a request procedure comprises the steps of:
sending a conference switchover indication message from a UE desiring the conference to the conference server, the UE desiring the conference being one of the plurality of UEs;
sending, by the conference server, a media information request message for requesting the media used during the PoC session, to the PoC server so as to set up a conference session;
sending, by the PoC server, uniform resource identifiers (URIs) and media information for the clients, used during the PoC session, to the conference server; and
sending, by the conference server, the media information received from the PoC server to the mixer, and allocating, by the mixer, media for a conference client using the media information.

10. The method of claim 9, wherein the media information includes a real-time transport protocol (RTP) port and a codec.

11. The method of claim 9, wherein after sending the URIs and the media information for the clients used during the PoC session, the PoC server sends to each of the clients a notification indicating that the PoC session is switched to the conference.

12. A system for providing push-to-talk (PTT) so as to conference through a mobile communication network between a plurality of clients, the system comprising:
a PTT over cellular (Poc) server for performing signaling and bearer handling for a PTT service, signaling for PTT to conference switchover, and bearer setup between the clients and a mixer for media processing for the conference;
the mixer for performing a media mixing function for the conference service, and allocating media resources to the clients;
a conference server for processing signaling for the conference, and interworking with the mixer to allocate a media channel for the clients; and
a plurality of user equipment (UE) that each serve as one of the plurality of clients.

13. The system of claim 12, wherein the PoC server generats billing-related data and reporting the billing data.

14. The system of claim 12, wherein the conference server generates billing-related data and reporting the billing data.

15. A user equipment (UE) equipped with a client for providing push-to-talk (PTT) so as to conference in a mobile communication network, the UE comprising:
a PTT service unit for processing a function of the client on the basis of a main control task of a real-time operating system; and
constituent elements in a physical layer and a medium access control (MAC) layer, for performing communication in association with the PTT service unit.

16. A method for switching over a unidirectional communication mode to a bidirectional communication mode during a push-to-talk (PTT) session between a plurality of user equipments (UEs) serving as clients in a mobile communication network including a PTT over cellular (PoC) server, the method comprising the steps of:
sending, by one of the UEs, a message for requesting bidirectional communication to the PoC server;
switching over, by the PoC server, the unidirectional communication mode to the bidirectional communication mode using a mixing function; and
sending, by the PoC server, an indication for enabling all PoC clients to substantially simultaneously talk to the UE, which is a PoC client, through a preset real-time transport protocol (RTP) channel.

17. The method of claim 16, wherein a message for requesting the bidirectional communication is a session initiation protocol (SIP) message.

18. The method of claim 16, wherein a message for requesting the bidirectional communication is an RTP control protocol (RTCP) message.

19. The method of claim 16, wherein the mixing function is performed in a media relay server (MRS) in the PoC server.

20. The method of claim 16, wherein the PoC server broadcasts information indicating the availability of the bidirectional communication to each of the PoC clients.

21. A system for switching a unidirectional communication mode to a bidirectional communication mode during a push-to-talk (PTT) session between a plurality of clients through a mobile communication network, the system comprising:
a PTT over cellular (PoC) server for performing signaling and bearer handling for a PTT service, and performing signaling for switching over the unidirectional communication mode to the bidirectional communication mode during the PTT session; and
a user equipment (UE) that serves as the client.

22. The system of claim 21, wherein the PoC server uses floor control signaling as the signaling for switching over to the bidirectional communication mode.

23. The system of claim 21, wherein the PoC server has a media mixing function for media processing for the bidirectional communication.

24. The system of claim 21, wherein the media processing includes one of media mixing and media bridging.

25. The system of claim 21, wherein the mixing function is performed in a media relay server (MRS) in the PoC server.

26. A user equipment (UE) equipped with a client for switching a unidirectional communication mode to a bidirectional communication mode during a push-to-talk (PTT) session in a mobile communication network, the UE comprising:
a PTT service unit for processing a function of the client on the basis of a main control task of a real-time operating system; and
constituent elements in a physical layer and a medium access control (MAC) layer, for performing communication in association with the PTT service unit.
